(19) United States
(12) Patent Application Publication
(10) Pub. No.: US 2001/0032966 A1
(43) Pub. Date: Oct. 25, 2001

(54) Anti-corrosion layer

(76) Inventor: Christina Schmidt, Siegen (DE)

Correspondence Address: PENDORF & CUTLIFF, Tampa Office, Post Office Box: 20445, Tampa, FL, 33622-0445, US

(21) Appl. No.: 09/814,480

(22) Filed: Mar. 15, 2001

(30) Foreign Application Priority Data
Mar. 18, 2000 (DE) 100 13 471.8

(51) Int. Cl. C09K 3/00; C23F 11/00

(52) U.S. Cl. 252/387; 252/389.3; 252/389.62

(57) ABSTRACT

The task of the invention is to provide an anti-corrosion layer for sheet metals, which exhibits corrosion inhibiting characteristics even after prolonged exposure to air and humidity.

This task is inventively solved thereby, that the filler is comprised at least partially of silicon.

The invention can be used to form anti-corrosion layers with a filler proportion of approximately 10 to 80 wt.-%.

The invention concerns an anti-corrosion layer or coating according to the pre-characterizing portion of patent claim 1. Anti-corrosion layers of this general type are known from the earlier filed, subsequently published DE 19903400.

Coatings for metallic surfaces must satisfy stringent requirements with regard to the desired corrosion protection, and particularly with respect to durability of such protective effects despite strongly changing environmental conditions to which vehicles of all types are subjected.

It is known, in the case of steel sheets, to provide a zinc coating and to coat these zinced sheets with an organic coating (DE-OS 19700319). It has, however, been found that in the conditions in which vehicles are used, zinced steel sheets, which are provided with phosphate and/or chromate layers as well as paint layers, are insufficient for a complete and durable protection against corrosion.

Zinced sheets can even be characterized as coating-resistant, in the case that zinc fine particle paint or course ground zinc particles are employed. This type of zinced sheet does not possess any guaranteed cathodic corrosion protection, since this type of zinc particle tends towards relatively rapid oxidation and thus to electrical insulation. The electrical conductivity of the corrosion protection layer is thus deteriorated to such an extent, that particularly with respect to rusting underneath, important cathodic protection effects are diminished or lost.

The same applies in the case of unzinced sheets, wherein it was attempted to incorporate fillers into organic coating materials for improvement of corrosion resistance, which fillers are comprised of electrically conductive metal particles which possess a negative electrical potential relative to the potential of the sheet metal. In the case of steel sheets there can be employed, for example, zinc, aluminum or magnesium. In these cases also, the metal particles oxidize and reduce the cathodic protective effect.

The above described breakdown of the cathodic protection by the oxidation of the zinc coating or the metal particles added to the organic protective coatings leads thereto, that after longer periods of time in air and humidity, the required corrosion protection drops off relatively rapidly.

In DE 19903400 filler materials with hollow structure, so called zeolites, are employed, which are loaded or charged with inhibitors and anti-oxidants.

In DE 30 01 882 C2 a corrosion inhibitor is disclosed in the form of oxidic particles with a size of up to 10 μm as filler for an anti-corrosion layer, to which corrosion reducing anions are bonded by ion exchange.

The release of the anions bound in this manner however occurs too rapidly, since reactive ions which diffuse through the layer but however are not intended to be bound, bond too rapidly to the corrosion inhibiting anions at the freely accessible points on the oxidative particles. This results in a disadvantageous all too rapid fading away of the corrosion inhibiting characteristics of the layer.

The task of the present invention is to provide an anti-corrosion layer for sheet metal, which exhibits corrosion inhibiting characteristics even after long periods of exposure to air and humidity.

This task is inventively solved by an anti-corrosion layer having the characteristics of Patent claim 1. Further developments of the invention are set forth in the dependent claims.

In accordance with the invention, silicon is used as a filler for coating of metal surfaces with, for example, suitable organic polymers.

One advantage of the inventive solution is comprised therein, that in the case of an environmentally induced permeation of oxygen and water through the polymer layer, the silicon reacts therewith to form corrosion-inhibiting silicon oxide compounds.

Si+2OH⁻+2H₂O→[H₂SiO₄]²⁻+2H₂↑

Si+2H₂O→SiO₂+2H₂↑

Si+O₂→SiO₂

This means, inhibitors are generated after exposure to air and humidity.

The portion of the filler in the inventive anti-corrosion layer is so determined, that it offers a sufficient corrosion protection for the sheet metal substrate against the oxygen and water capture. It could correspond to 10 to 80 weight percent. As filler materials, substances such as zeolites can supplementally be employed, which have a large surface area and are in the form of hollow chamber structures or honeycombs. Suitable zeolite types are ZSM5, H-Mordinite and Alite 180.

In the hollow chamber structures, oxygen and water can at least partially be bound. The employment of hydrophobic zeolites is advantageous, since these further discourage the residency and diffusion of water in the coating.

The hollow chamber structures are however also good for take-up and/or adsorption of supplemental inhibitors and/or anti-oxidants.

Advantages are also found in the mixing in of finally ground zinc particles, since these react with the silicon and the atmospheric oxygen to form passive working ZnSi-oxide compounds.

The adsorbed inhibitors and/or anti-oxidants further exhibit an advantageous capturing effect on the oxygen molecules diffused into the polymer layer, and therewith reduce the oxidation of the substrate surface, whereby the long-term duration of the corrosion protection is improved.

As suitable inhibitors there can be employed selectively carboxylic acids, amines, ketones, aldehydes and heterocylic compounds. Also, phosphates, benzoates, silicates, vanadates, tungstates, zirconates, borates or molybdates or similar substances can be employed.

Suitable anti-oxidants include vitamin C or salts thereof or vitamin E or aromatic aldehyde compounds (for example, 1,2- or 2,4-dihydroxybenzaldehyde, or phthalaldehyde or terephthalaldehyde or catechol) and similar substances, such as amines, zirconates or benzotriazoles which develop their surface active effect after they have reacted with oxygen.

The particle size of the filler to be employed depends upon the desired layer thickness of the anti-corrosion layer and should be between 0 and approximately 50 μm. The above mentioned filler materials can be adjusted in particle size by grinding.

For the filling or charging of the filler material with inhibitors and/or anti-oxidants, various processes are possible depending upon the material state of these substances.

In the case that the inhibitors and/or the anti-oxidants are solid substances, then they can be dissolved in a suitable solvent and stirred or mixed with dry filler material at room temperature. For this, the person of ordinary skill can select from known suitable solvents for dissolving the inhibitors and anti-oxidants.

Liquid inhibitors and anti-oxidants can be added to a column filled with the selected, dried filler material, wherein the loading or charging of the filler material with the substances occurs according to the known principle of column chromatography.

Further, there is the possibility of transitioning the solid or liquid loading/charging substances into the gas phase, and to add these via a column, which is filled with the selected dried filler material. The loading of the filler material with the substances occurs in this process according to the known principle of gas chromatography.

In the following, selected embodiments of the inventive anti-corrosion layer are described in greater detail.

| Raw Material | | Proportion (wt.%) |
|---|---|---|
| 1. | Polyurethane-acrylate | 50-80 |
| | (Viatkin VTE 6171/55MPFA) | |
| 2. | Reactive thinning agent | 5-30 |
| | (hexane dioldiacrylate HDDA) | |
| 3. | Photoinitiator (Darocur 1173) | 1-10 |
| 4. | Additive (Additol) | 1-10 |
| 5. | Butylacetate | 5-10 |
| 6. | Silicon | 10-80 |
| 7. | Zeolite | 4-80 |

The first five substances are stirred into each other in the indicated sequence. Silicon and zeolite-together representing maximally 80 wt. % of the ingredients-are worked into a paste using a small amount of solvent, which is subsequently added to the mixture of the first five substances. The application onto a metal substrate occurs by a doctor blade or squeegee. For hardening, the layer is ventilated at 40° C. for approximately 10 hours and then irradiated with UV-radiation at 80 W/cm for approximately 30 seconds.

The following mixture exhibited particularly good properties as an anti-corrosion layer:

| Raw Material | | Proportion (wt. %) |
|---|---|---|
| 1. | Silicon | 95 |
| 2. | Zeolite | 4.0 |
| 3. | Methyoxypropanol | 5.5 |
| 4. | Butylglycol (solvent) | 27 |
| 5. | Epoxy resin | 1.2 |
| 6. | Butylglycol (solvent) | 41 |
| 7. | Rheological aid | 0.5 |
| 8. | Wetting agent | 0.5 |
| 9. | Phenolic resin | 0.75 |
| 10. | H₃PO₄ (catalyst) | 0.5 |

In this composition, first raw materials 1 through 4 and 5 through 9 were mixed, thereafter the two mixtures were added to each other. Finally the catalyst H₃PO₄ was added.

Silicon was found to be particularly suitable for improving the protection against corrosion of phenolic resin and phenol-epoxy resin systems.

1. Anti-corrosion layer having a proportion of approximately 10 to 80 wt.-% filler, with filler is comprised at least partially of silicon, thereby characterized, that the filler further includes zeolite.

2. Anti-corrosion layer according to claim 1, thereby characterized, that the zeolite is of the type ZSM5 and/or H-Mordinite and/or Alite 180.

3. Anti-corrosion layer according to claim 1 or 2, thereby characterized, that it additionally includes inhibitors and/or anti-oxidants, which are preferably adsorbed to the filler materials.

4. Anti-corrosion layer according to claim 3, thereby characterized, that as inhibitors preferably phosphate, benzoate, silicate, vanadate, tungstate, zirconate, borate or molybdate are added.

5. Anti-corrosion layer according to one of claims 3 or 4, thereby characterized, that the anti-oxidants are selected from vitamin C or salts thereof, or vitamin E, or aromatic aldehyde compounds.

6. Anti-corrosion layer according to one of claims 1 through 5, thereby characterized, that the particle size of the filler material is between 0 and 50 μm, depending upon the desired layer thickness of the anti-corrosion layer.

7. Anti-corrosion layer according to one of claims 1 through 6, thereby characterized, that the fillers are charged by stirring of dissolved filler materials and dissolved charging substances, or, in the case of liquid charging substances and solid fillers, according to the principle of column chromatography, or, in the case of gaseous charging substances and solid fillers, according to the principle of gas chromatography.
